(19) United States
(12) Patent Application Publication
(10) Pub. No.: US 2009/0119216 A1
(43) Pub. Date: May 7, 2009

(54) System for rental or sale of multimedia files

(76) Inventor: Livio Dalla Valle, Costabissara (IT)

Correspondence Address: Modiano & Associati;Via Meravigli 16, 20123, Milan I, IT

(21) Appl. No.: 11/989,216

(22) PCT Filed: Jul. 26, 2006
(86) PCT No.: PCT/EP2006/007384

§ 371 Date: Jan. 22, 2008

(30) Foreign Application Priority Data
Aug. 5, 2005 (IT) VR2005A000098
Sep. 29, 2005 (IT) VR2005A000117

(51) Int. Cl. H04L 9/00; G06Q 10/00

(52) U.S. Cl. 705/59; 705/1

(57) ABSTRACT

A system for the rental or sale of multimedia files, comprising a vending machine for multimedia files associated with means for the transfer of the multimedia files to a storage medium owned by a user.

### TECHNICAL FIELD

The present invention relates to a system for rental or sale of multimedia files, particularly but not exclusively of movies in digital format.

### BACKGROUND ART

Stores or vending machines for the rental of movies on videocassettes and on digital media, such as so-called DVDs, are currently extremely widespread.

The users of such services generally have to perform a sort of registration with the operator of the store or of the vending machine, in some cases paying a subscription fee and receiving, in the case of vending machines, a top-up card which allows to rent movies.

In practice, the user, if he wishes to rent a movie, goes to the vending machine, accesses by means of a video interface a data bank capable of showing the available movies, and then selects among the movies that are available at that time the one that he wishes to rent.

After viewing the movie, the user must return to the vending machine (or to the store) and return the rented medium.

It is evident that although this system is currently extremely widespread it suffers drawbacks.

First of all, the movie that one initially wishes to view is very often not available, since especially for first-release movies the copies available at that specific vending machine (or store) have already been rented by other users.

Moreover, in view of the large number of new movie releases, it is evident that it is not physically possible to keep all movies available to the user, with the result that after a certain period of time from the release of the movie, it is quite difficult to be able to rent it.

Finally, it should be noted that although digital media are now used predominantly, due to the large number of rentals such media become damaged, consequently reducing or compromising the viewing quality.

### DISCLOSURE OF THE INVENTION

The aim of the present invention is to eliminate or at least reduce drastically the drawbacks noted above by providing a new system for the rental or sale of multimedia files, particularly but not exclusively movies in digital format.

Within this aim, an object of the present invention is to provide a system for the rental or sale of multimedia files that allows rapid and effective rental (or purchase) of multimedia files.

Another object of the present invention is to provide a system for the rental or sale of multimedia files that ensures that the user can rent or purchase all movies, even the latest releases, without the risk of a particular movie being unavailable.

Still another object of the present invention is to provide a system for the rental or sale of multimedia files that spares the user from having to return, after viewing the movie, to the store or vending machine to return the medium.

This aim and these and other objects, which will become better apparent hereinafter, are achieved by a system for the rental or sale of multimedia files, characterized in that it comprises a vending machine for multimedia files associated with means for the transfer of said multimedia files to a storage medium owned by a user.

### BRIEF DESCRIPTION OF THE DRAWINGS

Further characteristics and advantages of the invention will become better apparent from the description of some preferred but not exclusive embodiments of a system for the rental or sale of multimedia files according to the invention, illustrated by way of non-limiting example in the accompanying drawings, wherein:

FIG. 1 is a perspective view of a vending machine;

FIG. 2 is a transverse sectional view of the storage medium inserted at the vending machine;

FIG. 3 is a perspective view of a storage medium;

FIG. 4 is a perspective view of a device for playing back multimedia files;

FIG. 5 is a perspective view of a storage medium associated with a playback device;

FIG. 6 is a front elevation view of a playback device connected to a device for viewing video files;

FIG. 7 is a schematic view of the different devices to which the vending machine is connected;

FIG. 8 is a perspective view of a particular embodiment of a data bank;

FIG. 9 is a block diagram of the connection channels for the distribution of the multimedia files;

FIG. 10 is a block diagram which illustrates schematically the devices associated with a preferred embodiment of the portable storage medium.

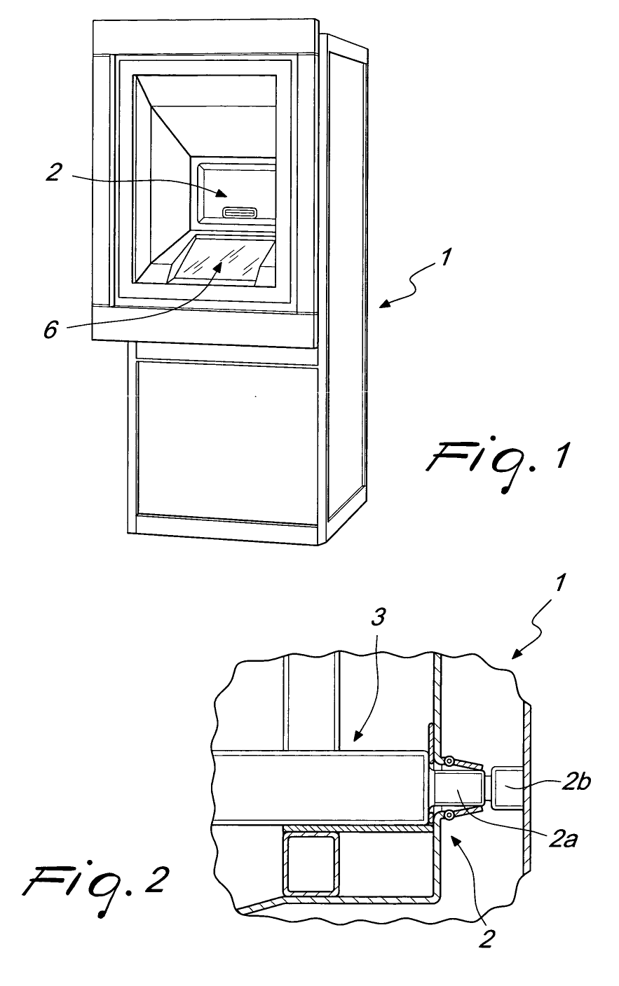

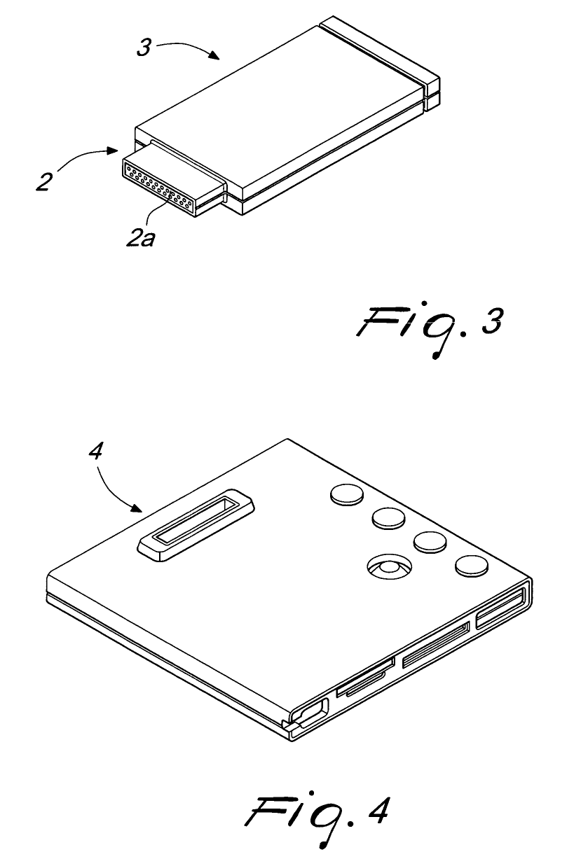

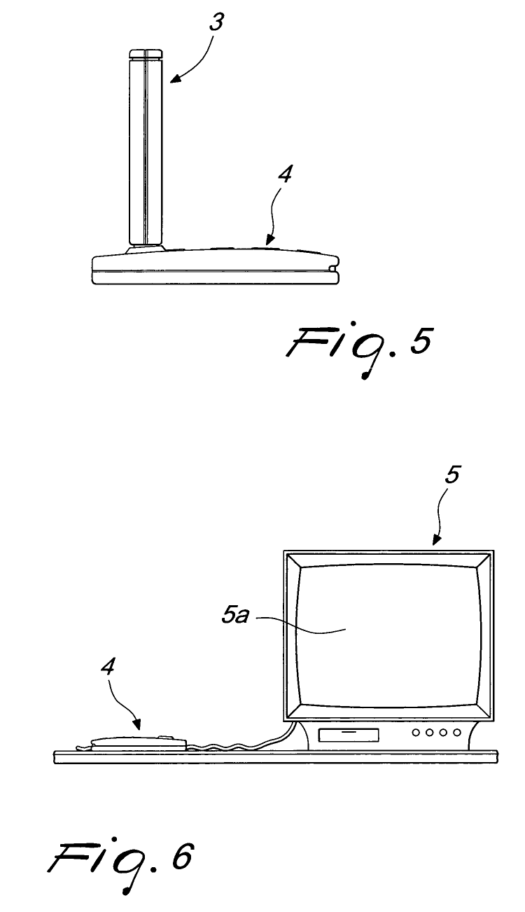

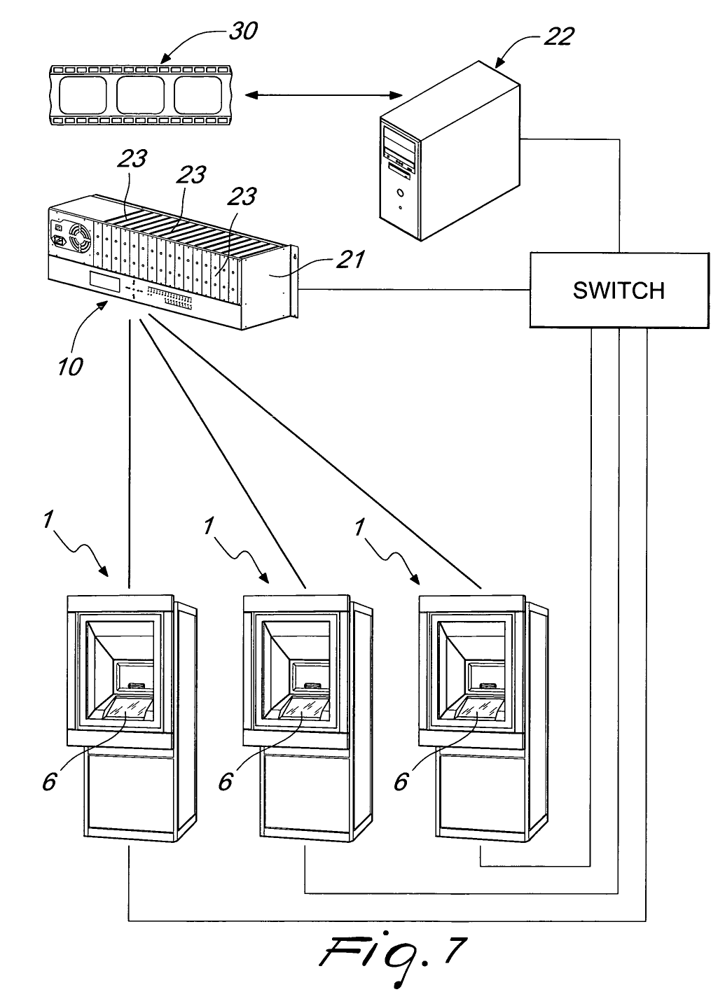

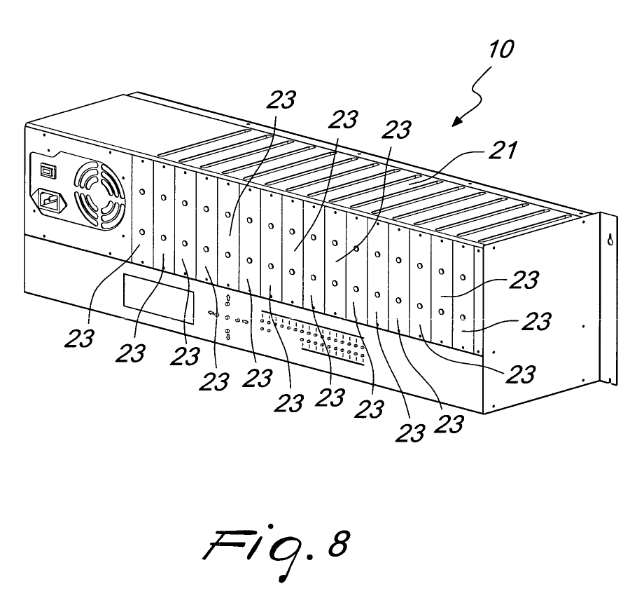

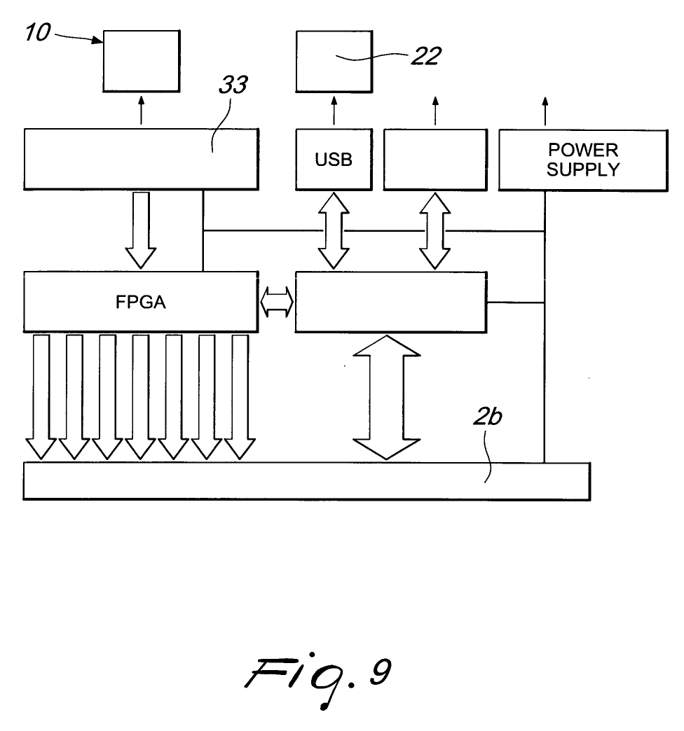

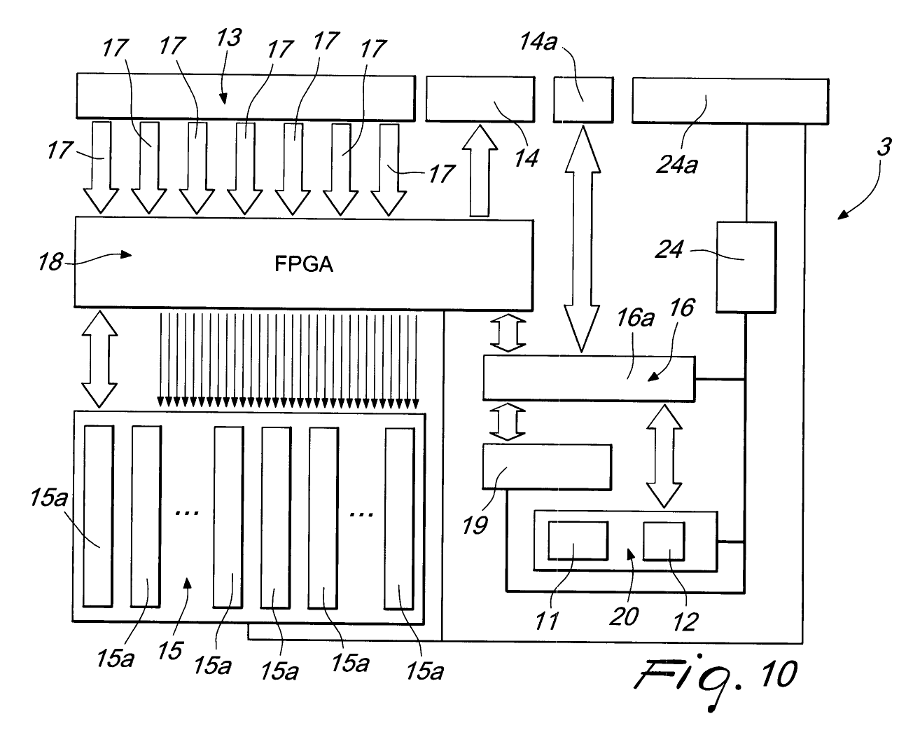

### WAYS OF CARRYING OUT THE INVENTION

In the exemplary embodiments that follow, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

The present invention relates to a system for the rental or sale of multimedia files.

In particular, said system comprises a vending machine 1 for multimedia files, which is associated with means 2 for transferring the multimedia files to a portable storage medium 3: the storage medium 3 can be used by a user who wishes to purchase or rent the multimedia files that can be dispensed by the vending machine 1.

In particular, the storage medium 3 can be connected to a device 4 for playing back the multimedia files, for example a set top box or a computer.

In order to allow a choice among a large number of multimedia files to be purchased or rented, the vending machine 1 can be connected to a data bank 10, which contains a plurality of multimedia files, among which the user can choose the one to rent or purchase.

Of course, if the purchased or rented multimedia files are image files or video files, the playback device 4 is associated with a device 5 for displaying the content of said multimedia files, such as for example a television set 5a or a monitor connected to a personal computer.

Advantageously, the storage medium 3 is owned by the user and in any case is available to the user.

According to a preferred embodiment, the multimedia files contained in the data bank 10 associated with the vending machines 1 comprise movies in digital format.

According to an important aspect of the present invention, the storage medium 3 comprises a device, preferably in the form of firmware 11, which is adapted to track, by means of a counter, the number of viewings purchased by the user; the device 11 is further preferably adapted to deduct from the counter one viewing substantially when the playback device 4 retrieves the data (or part of the multimedia file) from said temporary storage medium 3.

Conveniently, the device 11 deducts the viewing from the counter when the playback device 4 begins to read the multimedia file.

The firmware contained in the device 11 can of course delete the corresponding multimedia file from the storage medium 3 once the viewings have ended (in practice, therefore, when the counter is at zero).

Advantageously, the device 11 can also be associated with an operation retrieval file (log) 12 designed to store all the operations performed by the customer, so as to be able to check in particular any errors that have occurred during the procedures for storing and viewing the movie.

Moreover, the storage medium 3 can be provided with at least two connectors, such as for example a first connector useful for the rapid transfer of the multimedia files 13 and a second connector 14 (for example of the USB type 14a) for connection to the computer.

The means 2 for transferring the multimedia files from the vending machine 1 to the storage medium 3 can be of various kinds. In any case, it is convenient to select transfer means that ensure a high transfer rate: among these, it is possible to use an interface of the SCSI type 2a associated with a transfer plug 2b, but also a rapid transfer USB port, and so forth.

Transfer means of the same kind can be provided between the storage medium 3 and the playback device 4.

Conveniently, in order to allow rental of the multimedia files contained in the data bank 10 and therefore allow the user to use the content of the multimedia files for a limited time period, the storage medium 3 is associated, as mentioned, with means for temporary storage of the multimedia files which can be controlled by the device 11.

For this purpose, the storage medium 3 may have a storage unit 15 and a control device 16.

Merely by way of example, the storage unit or units 15 can be constituted by a hard disc or by a solid-state memory, while the control device 16 may provide a program, associated with the device 11, which is adapted to delete, after a certain period of time (in practice after the selected rental period), the multimedia files stored in the storage unit 15.

According to a preferred embodiment, the storage medium 3 has multiple storage units, each of which is, for example a FLASH EPROM 15a: these devices have in fact proved to be particularly suitable, since they are characterized by the possibility of great prospective growth in terms of capacity for an equal cost, by high reliability, since they are constituted by integrated circuits (and therefore are resistant to impacts and any falls, since there are no mechanical moving parts), and by very small dimensions.

With particular reference to the exemplifying configuration shown in FIG. 10, it can be seen that in this case the storage medium 3 has seven data inputs 17. Each of these inputs can work with a transfer rate of 100 MB per second, for a total of 700 MB per second of total data transfer rate.

Storage on the FLASH EPROMs 15a is managed by the FPGA integrated circuit 18.

This FPGA integrated circuit 18 acts as a logic gate, which is adapted to split the input data stream in order to send the data simultaneously to the FLASH EPROMs 15a.

In this case, the storage rate of the 8-bit FLASH EPROMs 15a is 20 MB per second. Accordingly, by using a module of 32 FLASH EPROMs for each storage medium 3, a data storage rate of 640 Mbyte per second.

As shown therefore in FIG. 10, the storage medium 3 further comprises a microprocessor 16a, a real-time clock 19, and an auxiliary FLASH EPROM 20, which is required for the operation of the device 11 in general and for the history of the log file 12; it is also advantageous for the temporary storage medium 3 to be provided with an integrated circuit for management of the USB interfaces 14 and 14a.

In particular, the auxiliary FLASH EPROM 20 stores, in addition to the firmware useful for management, auxiliary information such as a 128-bit code for decrypting the authorization and an identification code of the temporary storage medium 3, said codes being advantageously useful for the proper operation of the device and being described in greater detail hereinafter.

Furthermore, the history of the log file 12 may record information that cannot be deleted by the user and other information that instead the user can control.

By way of example, among the information that cannot be deleted by the user it is possible to list the following:
the time and date of the insertion of the storage medium 3 in the vending machine 1;
the storage of the data related to the vending machine 1 and to the operator of said vending machine 1;
the date and time of selection of the movie;
the type of use of the movie (time-dependent rental, rental of a number of viewings, purchase);
the type of payment made (cash, ATM card, credit card);
the balance in case of subscriptions or credits;
the date and time of the beginning of the transfer of the movie;
the date and time of the end of the transfer of the movie onto the storage medium;
if the transfer has not been completed correctly, the date, time and cause of the incorrect and/or incomplete transfer;
the date and time of interruption of the connection to the vending machine 1;
the time, date and code of the playback device for viewing the movie;
the storage of the movie in the file of already-viewed movies;
the date and time of any temporary stopping of viewing (in the case of the purchase of one or more viewings);
the date and time of the end of the viewing.

The user might also be allowed to control certain information (such as the file of already-viewed movies or the PIN code for purchasing or renting adult-rated movies) by deleting the data stored in the history of the log file 12.

Of course, the PIN code that allows these rentals is released after verifying the age of the owner (or a user) of that particular storage medium 3.

Nothing forbids the provision of additional means 2 for the transfer of multimedia files, which allow to transfer the multimedia files from the storage unit 15 to a storage device (for example the hard disc of a PC): these additional transfer means can comprise interface means of the USB type.

According to a particular aspect of the present invention, the control device 16 can be associated with an identification code, which is adapted to allow the playback of the multimedia files stored in the storage medium 3 exclusively by a respective playback device 4 associated therewith, in order to prevent the same multimedia files from being used by different users.

Of course, the vending machine 1 has a user interface 6 to allow the user to select a multimedia file to be purchased or rented.

According to another important aspect of the present invention, the device 11 (and more generally the microprocessor 16a) is powered by a small battery (which can be constituted conveniently by a rechargeable battery 24), so as to make this device autonomous and always operational.

The temporary storage medium 3 can of course be provided with power supply means 24a, which are adapted to receive power from external sources, for example from the electric mains, or also by means of interfaces, such as for example the USB interface, which are capable of supplying sufficient power.

It is possible to associate with the device 11 a viewing device, such as a display optionally provided with buttons in order to allow the viewing of the data related to the stored and viewed multimedia files.

The storage medium 3 (or some partition regions thereof) might also be identified by a conveniently unique identification code, which can be associated with the log file 12.

Said code, optionally paired with a personal PIN code, might allow, as already described, the rental or purchase at certain conditions, such as the legal age of the owner of said PIN code, of particular multimedia files, such as movies rated for viewers above a certain age.

In particular, a practical example of implementation and use of a system for the rental or sale of multimedia files (for example movies on DVD) according to the invention is described hereinafter.

Motion picture production/distribution companies encrypt the movie, typically with a variable 128-bit encryption key, so as to make the viewing of the movie impenetrable to anyone who does not have the decryption key.

Once the movie (file) has been encrypted, the production/distribution companies send the medium (generally a DVD) that contains the movie to the different operators. It is of course possible to send the encrypted movie over the Internet, if of course the data transfer rate allow this.

The operator then loads the movie into his data bank 10. Said data bank 10 can be constituted by a storage unit 21, and the movie can be stored in said storage unit 21 by using a reader connected to a server of the operator 22 and with the aid of a partitioning program capable of dividing the encrypted movie into a plurality of parts, each of which is stored in a partition region 23 of the storage unit 21.

Merely by way of example, the storage unit 21 can be constituted by a plurality of parts (for example sixteen) 23, each constituted by a hard disk, by a control card with direct inputs of the hard disks and outputs with fiber-optics transceiver devices, and by a power supply.

The movies are stored in the storage unit 21 and in particular on the hard disks by recording for each disk one portion (in the described example, 1/16th) of the entire movie; actually, it is convenient to record a second portion (sixteenth) of the movie on a second hard disk so that if one hard disk fails it is still possible to perform the subsequent transfers.

This solution (i.e., splitting the movie into parts) allows to reduce the transfer times of the movie from the storage unit 21 to the storage medium 3.

With a storage unit 21 provided with sixteen hard disks, the transfer times, if the sixteen hard disks operate simultaneously, are in fact reduced by sixteen times, and therefore the transfer time of a movie (which typically has a size of approximately 6 Gbyte) is reduced to approximately 10-12 seconds and is therefore compatible with the requirements of the operator and of the user.

Again with reference to the storage unit 21, it is convenient to note that by using sixteen hard disks with a capacity of 300 Gbyte each it is possible to store approximately four hundred movies in each storage unit.

Obviously, the system also allows to achieve higher storage capacities both by increasing the capacity of the individual hard disks and by arranging a plurality of storage units 21 in parallel.

As explained before, the user, once he owns his storage medium 3, inserts it or connects it by way of the multimedia file transfer means 2 to the vending machine 1, and after selecting the movie waits for the recording.

Authorization to transfer the movie from the storage unit 21 to the storage medium can be provided by the production/distribution company 30 by means of a request sent by the management program, by means of an Internet connection, to the server of said production/distribution company.

The following information can be sent in the request: the title of the movie (or code), the type of use (number of viewings, viewing time, purchase), the operator code, the storage medium code (identification code).

All this information is then processed by the management program of the production/distribution company and entered into an authorization file.

The authorization code and the decryption key of the movie, conveniently encrypted again with 128-bit encryption, are inserted in the authorization file, which is returned by the server of the production/distribution company to the server of the operator 22, again in real time and over the Internet. After obtaining the authorization, the system downloads (or more appropriately, transfers) the movie onto the storage medium 3 of the user and optionally the authorization file, encrypted with 128-bit encryption, is also recorded onto the device of the firmware type 11.

The firmware-type device 11, which is present both in the storage unit 21 and in the storage medium 3, also includes the decryption key of the authorization file. Of course, it is not possible for anyone to read the information inside the processors, since the read input is enabled by means of a 128-bit password.

Once the movie has been transferred onto the storage medium 3, the user can view the rented movie by connecting the storage medium 3 to the playback device (such as an appropriate base connected to the television set).

The storage medium 3 passes the decryption key to the playback device and then starts to send the data of the movie so as to allow to view it.

Once the viewing terms have expired (number of residual viewings equal to zero or viewing time set to zero), the firmware-type device 11 deletes the movie from the storage medium.

The connection between the storage unit 21 and the data reading/writing devices of the storage medium 3 arranged proximate to the user interface 6 is provided by means of a fiber-optics connection. It is advantageous to provide the device that converts the electrical signals into light pulses for the optical fibers by using a so-called transceiver 33. Currently, the transceivers 33 that are used are capable of carrying data at a rate of 4.25 Gbit per second and accordingly the transfer time of a movie is approximately 12 seconds and is therefore compatible with the other data transfer operations.

Operation of a system for the rental or sale of multimedia files according to the invention is evident from what has been described above.

In particular, a user, who has a storage medium 3 available, if he wishes to rent a multimedia file (for example a movie), merely has to go to a vending machine 1. With no need to have a card with the operator of that particular vending machine, by means of the user interface 32 he selects the movie to be transferred (temporarily) onto his storage medium by paying in cash (or by means of an ATM card or credit card) the price of the rental according to the storage duration that he has selected (3 hours, 6 hours, 1 day, etc) or according to the number of rented viewings or also the purchase of the movie.

The user can then read, by using a playback device 4, the multimedia file stored on the storage medium 3 and, if it is a movie, view it on his television set or on the computer monitor.

By providing the identification code and/or the authorization code, it is possible to allow the stored multimedia file to be read only by the playback device 4 or only if it is transferred to that particular storage medium 3 associated therewith, thus preventing the user from making any copies of the stored file, both in the case of rental (temporary file) and in the case of purchase, since said file is encrypted.

Moreover, thanks to the fact that the decryption code and the authorization code are released directly by the production/distribution company, said companies have maximum protection and are always aware in real time of the requests for rental and/or purchase.

The data bank associated with the vending machine 1, which is merely a sort of server on which a plurality of multimedia files are stored which can be updated continuously by being connected directly (for example over the Internet or by transfer from a medium such as a DVD) to movie distribution companies, further allows to send, indeed in real time to the distribution companies the information related to sold and rented movies.

In particular, if the system uses a firmware-type device 11, if the user wishes to purchase four viewings of the movie, he pays at said vending machine the cost of said four viewings. Every time the playback device starts to play the corresponding multimedia file contained on the medium, said firmware-type device deducts one viewing from the counter.

At the end of the fourth viewing, the firmware device 11 deletes the multimedia file from the storage device. A trace both of the purchase operation and of the viewing operations remains in any case in the log file 12, so as to allow to settle any disputes.

All the characteristics of the invention indicated above as advantageous, convenient or the like may also be omitted or be replaced with equivalents.

The system thus conceived is susceptible of numerous modifications and variations, all of which are within the scope of the appended claims.

All the details may further be replaced with other technically equivalent elements.

It has been found that the system devised and described above has achieved the intended aim and objects.

In particular, the user does not have to return the medium after viewing the movie. The files to be rented (and, among these, the movies related to the latest releases) are always available, and the quality is always perfect, since the medium is not damaged.

Moreover, the operator is no longer forced to keep in store more than one copy of the movie or of the multimedia file in general.

Moreover, production/distribution companies also have advantages in economic terms and a reduction of piracy. In particular, it is possible to provide for advance payment by the operator of an amount that corresponds to a certain number of rentals, which is indicated in the server of said operator.

This amount is decreased as users rent the movie. When the amount prepaid by the operator is about to end, the management program warns the operator that availability is about to end, and if the operator wishes to keep the movie available to users he makes a new payment to the production/distribution company. Otherwise, once the amount has been used up, the authorization of the production/distribution company to transfer the movie from the storage unit to the storage medium is denied.

Finally, it is evident that the cost (both for purchase and management) of a vending machine thus structured is considerably lower than that of traditional ones.

The disclosures in Italian Patent Applications No. VR2005A000098 and VR2005A000117 from which this application claims priorities are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

What is claimed is:

1-21. (canceled)

22. A system for the rental or sale of multimedia files, comprising a vending machine for multimedia files which is associated with means for the transfer of said multimedia files to a portable storage medium owned by a user.

23. The system for the rental or sale of multimedia files according to claim 22, wherein said portable storage medium is connected to a device for playing back said multimedia files.

24. The system for the rental or sale of multimedia files according to claim 22, wherein said portable storage medium is connected to a device for playing back said multimedia files by means of a same interface.

25. The system for the rental or sale of multimedia files according to claim 22, wherein said vending machine is connected to a data bank which contains a plurality of multimedia files.

26. The system for the rental or sale of multimedia files according to claim 23, wherein said playback device is associated with a device for viewing the content of said multimedia files.

27. The system for the rental or sale of multimedia files according to claim 22, wherein said multimedia files comprise movies in digital format.

28. The system for the rental or sale of multimedia files according to claim 25, wherein said portable storage medium is associated with means for temporary storage of said multimedia files.

29. The system for the rental or sale of multimedia files according to claim 28, wherein said temporary storage medium comprises a storage unit.

30. The system for the rental or sale of multimedia files according to claim 28, wherein said temporary storage medium comprises a device which is adapted to store on a counter the number of viewings purchased by said user or the rental time of said multimedia file and is adapted to deduct from said counter one viewing substantially when said playback device acquires the data related to said multimedia file from said temporary storage medium.

31. The system for the rental or sale of multimedia files according to claim 30, wherein said device of the storage medium, when said counter is at zero, or when the rental time has ended, deletes the corresponding multimedia file from said temporary storage medium.

32. The system for the rental or sale of multimedia files according to claim 30, wherein said device of the storage medium is associated with a log file, which is designed to store all the operations performed by the user.

33. The system for the rental or sale of multimedia files according to claim 30, wherein said device of the storage medium comprises a viewing device provided with at least one control button in order to allow the viewing of the data related to the stored and viewed multimedia files.

34. The system for the rental or sale of multimedia files according to claim 28, wherein said temporary storage medium comprises an identification code which can be associated with the log file.

35. The system for the rental or sale of multimedia files according to claim 28, wherein said temporary storage medium comprises a personal PIN code for the rental at specific conditions, such as legal age of the owner of said PIN code, of particular multimedia files.

36. The system for the rental or sale of multimedia files according to claim 29, wherein said storage unit comprises a FLASH EPROM.

37. The system for the rental or sale of multimedia files according to claim 22, wherein said means for the transfer of said multimedia files from said vending machine to said storage medium comprise transfer devices with a high transfer rate.

38. The system for the rental or sale of multimedia files according to claim 22, wherein said storage medium comprises an identification code, which allows the multimedia files stored in said temporary storage medium to be read exclusively by a respective playback device.

39. The system for the rental or sale of multimedia files according to claim 22, wherein said vending machine has a user interface for the choice, on the part of the user, of a multimedia file to be purchased or rented.

40. The system for the rental or sale of multimedia files according to claim 25, wherein said multimedia file contained in said data bank is encrypted, said system sending, before the transfer of the multimedia file from said data bank to said temporary storage medium, a request for authorization to the production/distribution company of said multimedia file, said production/distribution company sending to said vending machine, following the analysis of said authorization request, a decryption key which is intended uniquely for the playback of said multimedia file stored on said temporary storage medium.

41. The system for the rental or sale of multimedia files according to claim 40, wherein said request for authorization comprises the sending of data related to the title of the multimedia file or of the corresponding code, the type of use (number of viewings, viewing time, purchase and/or operator code and/or storage medium code).

42. The system for the rental or sale of multimedia files according to claim 40, wherein authorization to said means for transferring said multimedia files from said data bank to said temporary storage medium is dependent on the sending of said decryption key by the production/distribution company.
